(19) United States
(12) Patent Application Publication
(10) Pub. No.: US 2026/0051436 A1
(43) Pub. Date: Feb. 19, 2026

(54) ELECTROMAGNETIC COIL AND ASSEMBLY METHOD THEREOF

(71) Applicant: Zhejiang Senstren Technology Co., LTD, Zhuji City (CN)

(72) Inventors: Wangping RU, Zhuji City (CN); Bin WEI, Zhuji City (CN)

(21) Appl. No.: 19/267,823

(22) Filed: Jul. 14, 2025

(30) Foreign Application Priority Data
Aug. 15, 2024 (CN) 202411121220.X
Aug. 15, 2024 (CN) 202421978843.4

(51) Int. Cl. H01F 27/28; H01F 27/06; H01F 41/06

(52) U.S. Cl. CPC H01F 27/2823; H01F 27/06; H01F 41/06

(57) ABSTRACT

An electromagnetic coil includes a frame, a first insertion piece, a second insertion piece, and a coil. A protrusion portion is disposed on the frame. The first insertion piece and the second insertion piece are disposed on two axial ends of the frame respectively. The wire is wound on the frame and has an input end and an output end. The input end is connected to the first insertion piece. The output end is configured to be wound on the protrusion portion and then connected to the second insertion piece.

### CROSS-REFERENCE TO RELATED APPLICATION(S)

This application claims priority to Chinese Patent Applications No. 202411121220.X and No. 202421978843.4 filed Aug. 15, 2024, the disclosure of which is incorporated herein by reference in its entirety.

### TECHNICAL FIELD

The present invention relates to the field of electromagnetic technology and, in particular, to an electromagnetic coil and an assembly method thereof.

### BACKGROUND

An electromagnetic coil mainly includes a frame, a wire, and two insertion pieces. The wire is wound on the frame to form a winding group. The wire has two end heads, namely an input end and an output end. In the related art, during winding, the input end is connected to one of the insertion pieces first, and then the wire is wound on the frame to form a winding group. After winding is completed, the output end of the wire is directly wound on the other insertion piece.

With this arrangement, the output end is directly pulled out to be connected to the insertion piece after the winding is completed. In this case, a long section of the wire is suspended. When the resin is coated by injection molding subsequently, it is possible that the coil is broken, which is caused by the breakage of the wire due to high injection pressure. Moreover, with this arrangement, the wire is easily loosened and exposed when the resin is coated by injection molding subsequently, which is prone to potential safety hazards.

Therefore, an electromagnetic coil and an assembly method thereof are urgently needed to solve the preceding problem.

### SUMMARY

The present invention provides an electromagnetic coil so that an output end can be in a tensioned state and prevented from being suspended, reducing the situation of the breakage of a wire due to high injection pressure and reducing potential safety hazards.

The present invention further provides an assembly technique of an electromagnetic coil that can solve the problem that the wire is easily loosened in an assembly process.

An electromagnetic coil is provided. The electromagnetic coil includes a frame, a first insertion piece, a second insertion piece, and a wire.

A protrusion portion is disposed on the frame.

The first insertion piece and the second insertion piece are disposed on two axial ends of the frame respectively.

The wire is wound on the frame and has an input end and an output end. The input end is connected to the first insertion piece. The output end is configured to be wound on the protrusion portion and then connected to the second insertion piece.

An assembly method of an electromagnetic coil is provided. The assembly method is configured to assemble the preceding electromagnetic coil. The assembly method includes the steps below.

In S30, an output end is partially wound and secured on a protrusion portion after winding a wire on a frame is completed.

In S40, a second insertion piece is assembled on the frame.

In S50, the output end is connected to the second insertion piece.

The present invention provides an electromagnetic coil. The protrusion portion is disposed on the frame. The output end may be wound on the protrusion portion to be pre-secured and then is connected to the second insertion piece. With this arrangement, the output end can be in a tensioned state and prevented from being suspended. When the resin is coated by injection molding subsequently, it can reduce the situation that the electromagnetic coil is broken caused by the breakage of the wire due to high injection pressure. Moreover, this arrangement can effectively prevent the wire from being loosened, prevent the wire from being exposed when the resin is coated by injection molding subsequently, and reduce potential safety hazards.

The present invention further provides an assembly method of an electromagnetic coil. Before the second insertion piece is assembled, the wire can be wound and secured on the protrusion portion in advance, preventing the wire from being loosened in the process of assembling the second insertion piece, making the operation convenient and quick, preventing the wire from being exposed when the resin is coated by injection molding subsequently, and reducing potential safety hazards. After the assembly is completed, the output end is partially wound on the protrusion portion so that the output end can be in a tensioned state and prevented from being suspended. When the resin is coated by injection molding subsequently, it can reduce the situation that the electromagnetic coil is broken caused by the breakage of the wire due to high injection pressure.

### BRIEF DESCRIPTION OF DRAWINGS

FIG. 1 is structural view one of an electromagnetic coil according to an embodiment of the present invention.

FIG. 2 is an enlarged view of part A of FIG. 1.

FIG. 3 is structural view two of an electromagnetic coil according to an embodiment of the present invention.

FIG. 4 is structural view one of a frame according to an embodiment of the present invention.

FIG. 5 is structural view two of a frame according to an embodiment of the present invention.

FIG. 6 is a structural view of a frame according to another embodiment of the present invention.

FIG. 7 is a structural view of a frame according to another embodiment of the present invention.

### REFERENCE LIST

10 frame
11 protrusion portion
111 winding segment
112 blocking end
12 winding portion
13 first stop portion
131 wire inlet guide groove
1311 arc surface
132 wire inlet extension groove
133 stopper
134 first reference wall
14 second stop portion
141 wire outlet guide groove
142 wire outlet extension groove
143 second reference wall
15 connection wall
20 first insertion piece
21 pressing portion
30 second insertion piece
40 wire
41 input end
42 output end

### DETAILED DESCRIPTION

The present invention is further described in detail hereinafter in conjunction with drawings and embodiments. It is to be understood that the embodiments described herein are intended to explain the present invention and not to limit the present invention. Additionally, it is to be noted that for ease of description, part, not all, of the structures related to the present invention are illustrated in the drawings.

In the description of the present invention, terms “joined”, “connected”, and “secured” are to be understood in a broad sense unless otherwise expressly specified and limited. For example, the term “connected” may refer to “securely connected”, “detachably connected”, or “integrated”, may refer to “mechanically connected” or “electrically connected”, may refer to “connected directly” or “connected indirectly through an intermediary”, or may refer to “connected inside two elements” or “an interaction relation between two elements”. For those of ordinary skill in the art, specific meanings of the preceding terms in the present invention may be understood based on specific situations.

In the present invention, unless otherwise expressly specified and limited, when a first feature is described as “above” or “below” a second feature, the first feature and the second feature may be in direct contact, or the first feature and the second feature may be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of this embodiment, orientations or position relations indicated by terms such as “upper”, “lower”, and “right” are based on the drawings. These orientations or position relations are intended only to facilitate description and simplify operations and not to indicate or imply that a device or element referred to must have such particular orientations or must be configured or operated in such particular orientations. Thus, these orientations or position relations are not to be construed as limiting the present invention. In addition, the terms “first” and “second” are used only for distinguishing between descriptions and have no special meaning.

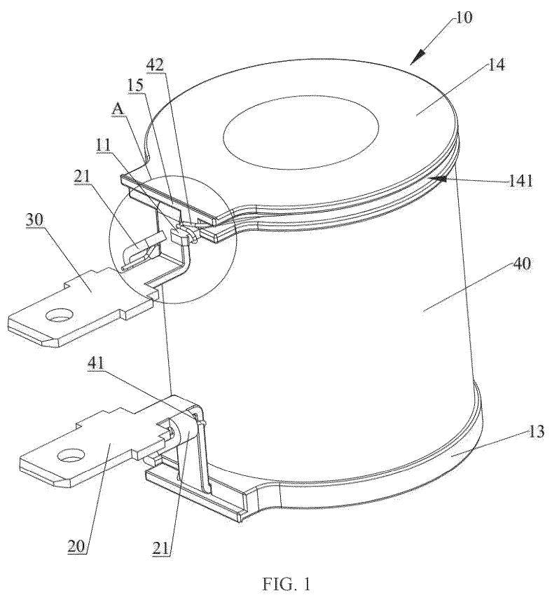

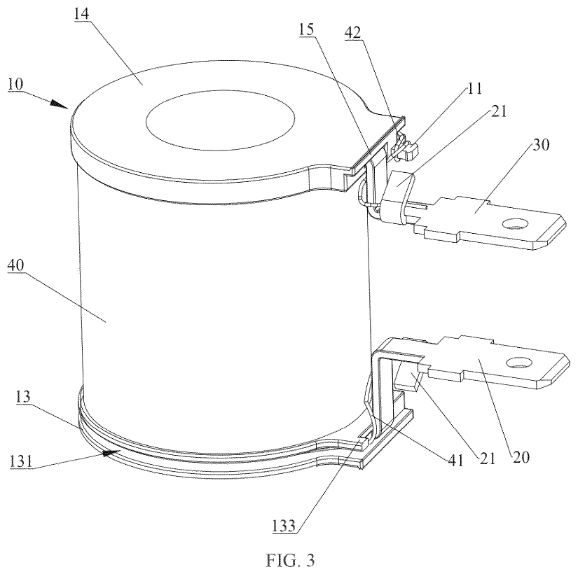

This embodiment provides an electromagnetic coil which may be applied to an electromagnetic valve. Specifically, as shown in FIGS. 1 and 3, the electromagnetic coil includes a frame 10, a first insertion piece 20, a second insertion piece 30, and a wire 40. A protrusion portion 11 is disposed on the frame 10. The first insertion piece 20 and the second insertion piece 30 are disposed on two axial ends of the frame 10 respectively and are configured to implement the electrical connection between the wire 40 and an external circuit. The wire 40 is wound on the frame 10 and has an input end 41 and an output end 42. That is, two free ends of the wire 40 are the input end 41 and the output end 42 respectively. The input end 41 is connected to the first insertion piece 20. The output end 42 is configured to be wound on the protrusion portion 11 and then connected to the second insertion piece 30. The wire 40 is optionally an enameled wire.

The protrusion portion 11 is disposed on the frame 10. After the winding on the frame 10 is completed, the output end 42 may be wound on the protrusion portion 11 to be pre-secured and then connected to the second insertion piece 30. With this arrangement, when the output end 42 is connected to the second insertion piece 30, the output end 42 can be in a tensioned state and prevented from being suspended. When the resin is coated by injection molding subsequently, it can reduce the situation that the electromagnetic coil is broken caused by the breakage of the wire 40 due to high injection pressure. Moreover, this arrangement can effectively prevent the wire 40 from being loosened, prevent the wire 40 from being exposed when the resin is coated by injection molding subsequently, and reduce potential safety hazards.

Optionally, the output end 42 is wound on the protrusion portion 11 and then connected to the second insertion piece 30. Specifically, the output end 42 may be wound twice or three times. The number of windings is not limited as long as the output end 42 is kept in a tensioned state after being connected to the second insertion piece 30.

Optionally, an insertion piece may be connected to the frame 10 through insertion. That is, each of the two axial ends of the frame 10 is provided with an insertion hole. The first insertion piece 20 and the second insertion piece 30 are inserted into respective insertion holes. The insertion manner makes the mounting operation of the first insertion piece 20 and the second insertion piece 30 convenient and quick. Optionally, an insertion piece and a respective insertion hole may be in an interference fit, thereby improving the firmness of the mounting of the insertion piece. In other embodiments, an insertion piece may be in threaded connection to or riveted with the frame 10, which is not limited here.

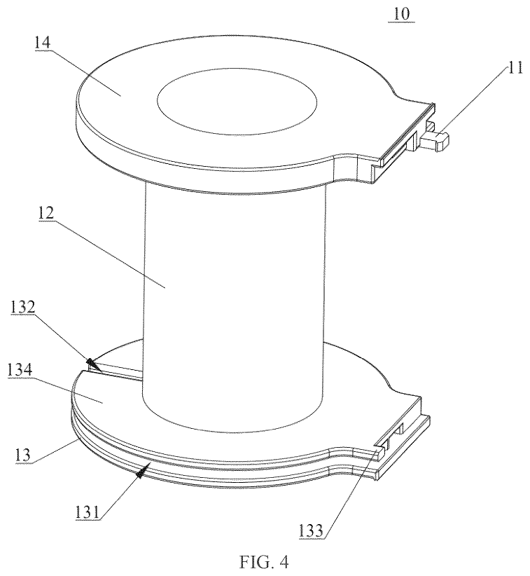

In an optional embodiment, as shown in FIGS. 3 and 4, the frame 10 includes a winding portion 12, a first stop portion 13, and a second stop portion 14. The winding portion 12 is configured for the wire 40 to be wound on the winding portion 12. The first stop portion 13 and the second stop portion 14 are disposed on two axial ends of the winding portion 12. The radial size of each of the first stop portion 13 and the second stop portion 14 is greater than the radial size of the winding portion 12. The first insertion piece 20 is disposed on a circumferential side of the first stop portion 13. The second insertion piece 30 is disposed on a circumferential side of the second stop portion 14. The winding portion 12 is cylindrical in shape. Each of the first stop portion 13 and the second stop portion 14 is disc-shaped and has a larger diameter than the winding portion 12. In this case, when the wire 40 is wound on the winding portion 12, the first stop portion 13 and the second stop portion 14 may restrict the axial movement of the wire 40, thereby positioning the wire 40.

In this embodiment, as shown in FIGS. 3 and 4, the protrusion portion 11 is disposed on the second stop portion 14. In this case, the protrusion portion 11 is closer to the second insertion piece 30, making it easier to wind the output end 42.

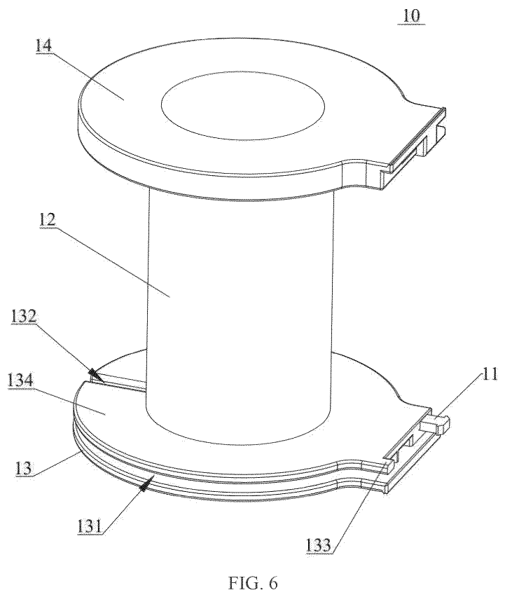

In another optional embodiment, as shown in FIG. 6, the protrusion portion 11 may also be disposed on the first stop portion 13 to implement winding the output end 42.

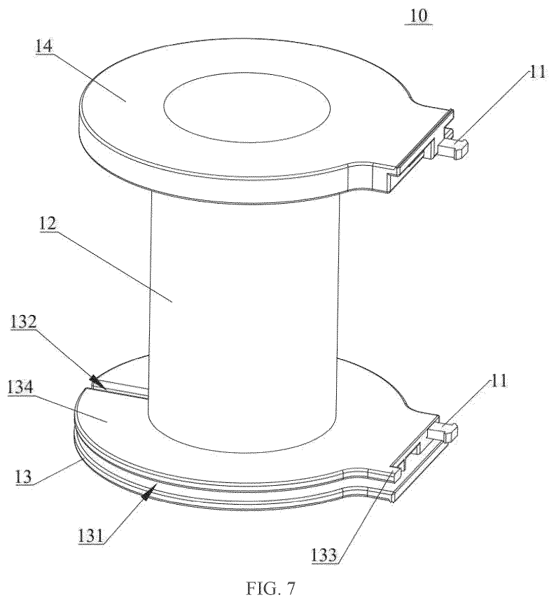

In another optional embodiment, as shown in FIG. 7, each of the first stop portion 13 and the second stop portion 14 may be provided with a protrusion portion 11. With this arrangement, the input end 41 may be wound on the protrusion portion 11 on the first stop portion 13 to be pre-secured and then is connected to the first insertion piece 20. Then the winding is performed on the winding portion 12. After the winding is completed, the output end 42 may be wound on the protrusion portion 11 on the second stop portion 14 to be pre-secured and then is connected to the second insertion piece 30. With this arrangement, both the input end 41 and the output end 42 can be in a tensioned state and prevented from being suspended. When the resin is coated by injection molding subsequently, it can reduce the situation that the electromagnetic coil is broken caused by the breakage of the wire 40 due to high injection pressure.

The present application is described with an example in which a protrusion portion 11 is disposed on the second stop portion 14.

In an optional embodiment, as shown in FIG. 1, the protrusion portion 11 and the second insertion piece 30 are located on the same radial side of the frame 10. Such an arrangement can better facilitate the winding and make the operation convenient and quick.

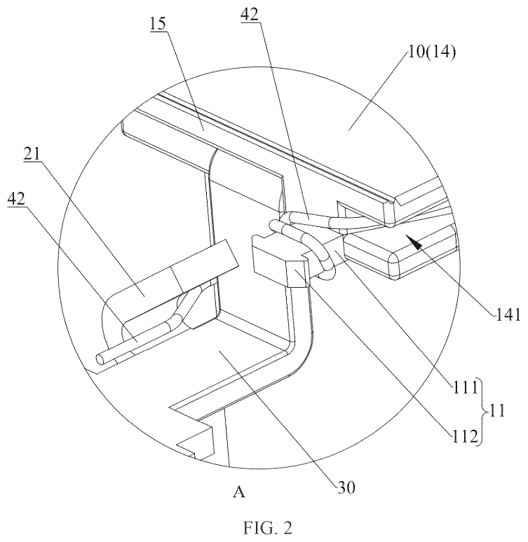

Further, as shown in FIGS. 1 and 2, the protrusion portion 11 is disposed beside the second insertion piece 30 in the circumferential direction of the frame 10. Such an arrangement can enable the protrusion portion 11 to be closer to the second insertion piece 30, shortening the length of the output end 42 between the protrusion portion 11 and the second insertion piece 30 and further reducing the possibility of the wire 40 being suspended.

In an optional embodiment, as shown in FIGS. 1 and 3, the frame 10 includes connection walls 15. A connection wall 15 is a planar wall. Moreover, a connection wall 15 is disposed on the second stop portion 14. The second insertion piece 30 is secured to the connection wall 15. The protrusion portion 11 and the frame 10 are of an integral structure. The protrusion portion 11 is arranged to protrude in a direction away from the axis of the frame 10 relative to the connection wall 15. The protrusion portion 11 and the frame 10 are made of the same material and are integrally molded by an injection molding process, reducing the cost of component production, saving the assembly link between multiple components, and making the structure more firm and durable. The connection wall 15 is formed on the second stop portion 14, facilitating the molding and processing of the protrusion portion 11 and better facilitating the assembly of the second insertion piece 30. Similarly, a connection wall 15 with the same structure is also disposed on the first stop portion 13, which is not repeated here.

In an optional embodiment, as shown in FIG. 2, the protrusion portion 11 includes a winding segment 111 and a blocking end 112. The winding segment 111 is disposed on the frame 10 and is configured for a part of the output end 42 to be wound around the winding segment 111. The blocking end 112 is disposed on an end of the winding segment 111 facing away from the frame 10. Two ends of the blocking end 112 protrude from the winding segment 111 in the width direction of the winding segment 111. The protruding length of each of the two ends is greater than the diameter of the wire 40 so that the protrusion portion 11 is constructed as a “T”-shaped structure. The protruding length of each end of the blocking end 112 is greater than the diameter of the wire 40. When the output end 42 of the wire 40 is wound on the winding segment 111, the outer ring of the wire loop formed after winding the output end 42 does not protrude from the blocking end 112. Therefore, the output end 42 of the wire 40 can be stably restricted to the winding segment 111, preventing the output end 42 from being disengaged from the protrusion portion 11. Therefore, the output end 42 can be stably wound outside the protrusion portion 11 to guarantee that the output end 42 is in a tensioned state.

In an optional embodiment, as shown in FIG. 3, a wire inlet guide groove 131 is disposed on a circumferential side wall of the first stop portion 13. A wire inlet end of the wire inlet guide groove 131 is located beside the first insertion piece 20. Under the guide of the wire inlet guide groove 131, the input end 41 is wound on the winding portion 12 so that the input end 41 can be hidden in the wire inlet guide groove 131, preventing the input end 41 from being in contact with the wire 40 and reducing the risk of a short circuit of the electromagnetic coil. Besides, the guide of the wire inlet guide groove 131 can also reduce the situation of the input end 41 being suspended.

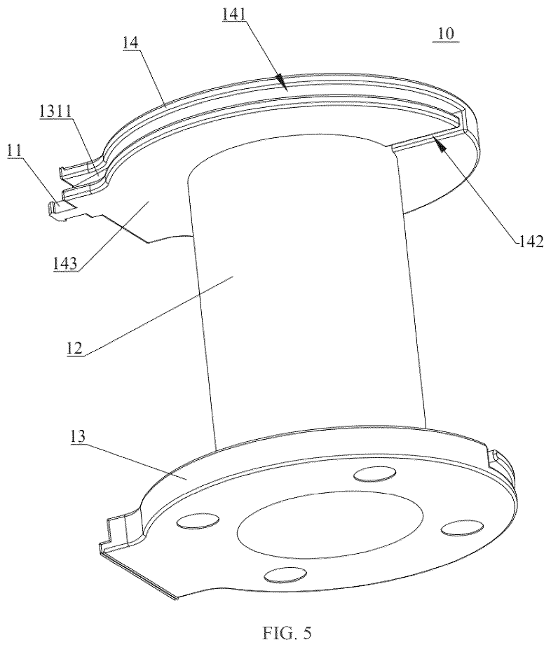

In an optional embodiment, as shown in FIGS. 4 and 5, a side of the first stop portion 13 facing the second stop portion 14 is defined as a first reference wall 134. A side of the second stop portion 14 facing the first stop portion 13 is defined as a second reference wall 143. A wire inlet extension groove 132 communicating with the wire inlet guide groove 131 is disposed on the first reference wall 134. The wire inlet extension groove 132 extends from a circumferential surface of the first stop portion 13 to a circumferential surface of the winding portion 12. In operation, the input end 41 of the wire 40 is first accommodated in the wire inlet guide groove 131. Then, after the input end 41 of the wire 40 is secured on the first insertion piece 20, the input end 41 reaches the wire inlet extension groove 132 along the wire inlet guide groove 131, passes through the wire inlet extension groove 132 and then reaches the winding portion 12. Moreover, the wire 40 is wound on the winding portion 12. The arrangement of the wire inlet extension groove 132 enables the input end 41 to be fitted to the frame 10 constantly and prevents the input end 41 from being suspended.

In an optional embodiment, as shown in FIGS. 3 and 4, a stopper 133 may also be disposed on an end of the wire inlet guide groove 131 facing the first insertion piece 20. The stopper 133 protrudes outward from a groove wall of the wire inlet guide groove 131 in the depth direction of the wire inlet guide groove 131. When the input end 41 is located in the wire inlet guide groove 131, the stopper 133 can stop the input end 41 from coming out of the wire inlet guide groove 131, thereby guaranteeing that the input end 41 can be stably located in the wire inlet guide groove 131 and kept in a tensioned state.

In an optional embodiment, as shown in FIGS. 1 and 5, a wire outlet guide groove 141 is disposed on a circumferential side wall of the second stop portion 14. The protrusion portion 11 is located beside a wire outlet of the wire outlet guide groove 141. Specifically, referring to FIG. 2, the protrusion portion 11 is located between the second insertion piece 30 and the wire outlet of the wire outlet guide groove 141. After the winding is completed, the output end 42 of the wire 40 is output from the wire outlet guide groove 141, is directly wound several times on the protrusion portion 11, and then is connected to the second insertion piece 30, shortening the length between the output end 42 and the protrusion portion 11 after the output end 42 is output from the wire outlet guide groove 141 and further reducing the possibility of the output end 42 being suspended.

Under the guide of the wire outlet guide groove 141, the output end 42 of the wire 40 can be restricted. Accordingly, after the output end 42 is wound and secured on the protrusion portion 11, the output end 42 is kept in a tensioned state in the wire outlet guide groove 141 and not in a suspended state. When the resin is coated by injection molding subsequently, it can avoid the situation that the electromagnetic coil is broken caused by the breakage of the wire 40 due to high injection pressure. Besides, the output end 42 can be hidden in the wire outlet guide groove 141, preventing the output end 42 from being in contact with the wire 40 and reducing the risk of a short circuit.

In an optional embodiment, as shown in FIG. 5, a wire outlet extension groove 142 communicating with the wire outlet guide groove 141 is disposed on the second reference wall 143. The wire outlet extension groove 142 extends from a circumferential surface of the second stop portion 14 to the circumferential surface of the winding portion 12. After the winding is completed, the output end 42 of the wire 40 is first input into the wire outlet guide groove 141 from the wire outlet extension groove 142. Then the output end 42 reaches the protrusion portion 11 along the wire outlet guide groove 141. The output end 42 is wound several times on the protrusion portion 11 and then is connected to the second insertion piece 30. The arrangement of the wire outlet extension groove 142 enables the output end 42 to be fitted to the frame 10 constantly and prevents the output end 42 from being suspended.

Referring to FIGS. 4 and 5, the opening of the wire inlet guide groove 131 and the opening of the wire outlet guide groove 141 face opposite directions. That is, the wire inlet guide groove 131 and the wire outlet guide groove 141 are located on two opposite sides of the frame 10 in the radial direction of the frame 10. Such an arrangement can better facilitate the winding.

In an optional embodiment, as shown in FIG. 5, a groove bottom wall of the wire outlet guide groove 141 is a smooth transitional arc surface 1311, thereby making the path of the wire gentler, preventing the output end 42 from being worn during the process of passing through the wire outlet guide groove 141, and avoiding damage to the enameled wire.

In an optional embodiment, a groove bottom wall of the wire inlet guide groove 131 is a smooth transitional arc surface, thereby making the path of the wire gentler, preventing the input end 41 from being worn during the process of passing through the wire inlet guide groove 131, and avoiding damage to the enameled wire.

It is to be noted that the input end 41 is usually securely connected to the first insertion piece 20 through soldering and that the output end 42 is usually securely connected to the second insertion piece 30 through soldering, thereby guaranteeing connection strength, better resisting the pressure of injection molding, and preventing a connection from being broken.

In an optional embodiment, as shown in FIG. 3, a pressing portion 21 is disposed on the first insertion piece 20. Specifically, the pressing portion 21 is a thin-wall protrusion structure integrally formed on the first insertion piece 20. The pressing portion 21 is rotatable relative to the first insertion piece 20 so that the pressing portion 21 presses a part of the input end 41 on the first insertion piece 20. With the preceding arrangement, in the process of soldering the input end 41 and the first insertion piece 20, the pressing portion 21 is rotated toward the first insertion piece 20 so that the pressing portion 21 presses a part of the input end 41 on the first insertion piece 20, guaranteeing a tight fit between the input end 41 and the first insertion piece 20 and thereby avoiding the phenomenon of false soldering after soldering due to a loose fit between the input end 41 and the first insertion piece 20.

In an optional embodiment, a pressing portion 21 is also disposed on the second insertion piece 30. The pressing portion 21 is rotatable relative to the second insertion piece 30 so that the pressing portion 21 presses a part of the output end 42 on the second insertion piece 30, guaranteeing a tight fit between the output end 42 and the second insertion piece 30 and thereby avoiding the phenomenon of false soldering after soldering due to a loose fit between the output end 42 and the second insertion piece 30. The pressing portion 21 on the second insertion piece 30 and the pressing portion 21 on the first insertion piece 20 have the same structure and merely different arrangement directions, which is not repeated here.

Optionally, a pressing portion 21 has an initial position (that is, the position in FIG. 3). The pressing portion 21 on the first insertion piece 20 is taken as an example. In this embodiment, an included angle between the pressing portion 21 at an initial position and the first insertion piece 20 is between 30° and 40°, optionally 30°. Such an arrangement guarantees that a certain space is left between the pressing portion 21 and the first insertion piece 20 for the input end 41 to pass through. Besides, this arrangement prevents the connection position between the pressing portion 21 and the first insertion piece 20 from being broken caused by an excessively large stroke of the rotation of the pressing portion 21 relative to the first insertion piece 20. In other embodiments, the included angle may be adaptively adjusted according to the fatigue strength of the material. The included angle may be, for example, 45° or 60° and is not specifically limited here.

Further, as shown in FIG. 5, the electromagnetic coil also includes a plastic-coated housing (not shown). The plastic-coated housing covers the frame 10 and the wire 40. A part of the first insertion piece 20 and a part of the second insertion piece 30 protrude out of the plastic-coated housing so that each exposed insertion piece can be more conveniently connected to an external device. The plastic-coated housing is a resin-coated housing formed by an injection molding process, thereby guaranteeing the tightness of the coating of the frame 10 and the wire 40 and thus guaranteeing a good insulation effect.

This embodiment further provides an assembly method of an electromagnetic coil. The assembly method is used for assembling the preceding electromagnetic coil. The assembly method includes the steps below.

In S30, the output end 42 is partially wound and secured on the protrusion portion 11 after winding the wire 40 on the frame 10 is completed.

In S40, the second insertion piece 30 is assembled on the frame 10.

In S50, the output end 42 is connected to the second insertion piece 30.

According to the assembly method of an electromagnetic coil provided in this embodiment, before the second insertion piece 30 is assembled, the wire may be wound and secured on the protrusion portion 11 in advance. Then the second insertion piece 30 is assembled. Such an arrangement prevents the wire 40 from being loosened in the process of assembling the second insertion piece 30, making the operation convenient and quick, preventing the wire 40 from being exposed when the resin is coated by injection molding subsequently, and reducing potential safety hazards. After the assembly is completed, the output end 42 is partially wound on the protrusion portion 11 so that the output end 42 can be in a tensioned state and prevented from being suspended. When the resin is coated by injection molding subsequently, it can reduce the situation that the electromagnetic coil is broken caused by the breakage of the wire 40 due to high injection pressure.

Further, before S30 the method further includes the steps below.

In S10, a first insertion piece 20 is assembled on the frame 10, and the input end 41 is passed through the wire inlet guide groove 131 and is connected to the first insertion piece 20.

In S20, the wire 40 is wound on the frame 10. Under the guide of the wire inlet guide groove 131, the input end 41 is wound on the winding portion 12 so that the input end 41 can be hidden in the wire inlet guide groove 131, preventing the input end 41 from being in contact with the wire 40 and reducing the risk of a short circuit of the wire 40. Besides, the guide of the wire inlet guide groove 131 can also avoid the situation where the input end 41 is suspended.

In an optional embodiment, S30 specifically includes the following: after winding the wire 40 on the frame 10 is completed, the output end 42 is passed through the wire outlet guide groove 141 and is guided onto the protrusion portion 11, and the output end 42 is partially wound and secured on the protrusion portion 11.

Under the guide of the wire outlet guide groove 141, the output end 42 of the wire 40 can be restricted. Accordingly, after the output end 42 is wound and secured on the protrusion portion 11, the output end 42 is kept in a tensioned state in the wire outlet guide groove 141 and not in a suspended state. When the resin is coated by injection molding subsequently, it can avoid the situation that the electromagnetic coil is broken caused by the breakage of the wire 40 due to high injection pressure. Besides, the output end 42 can be hidden in the wire outlet guide groove 141, preventing the output end 42 from being in contact with the wire 40 and reducing the risk of a short circuit.

What is claimed is:

1. An electromagnetic coil, comprising:
a frame, wherein a protrusion portion is disposed on the frame;
a first insertion piece and a second insertion piece disposed on two axial ends of the frame respectively; and
a wire wound on the frame and having an input end and an output end, wherein the input end is connected to the first insertion piece, and the output end is configured to be wound on the protrusion portion and then connected to the second insertion piece.

2. The electromagnetic coil according to claim 1, wherein the protrusion portion and the second insertion piece are located on a same radial side of the frame.

3. The electromagnetic coil according to claim 2, wherein the protrusion portion is disposed beside the second insertion piece in a circumferential direction of the frame.

4. The electromagnetic coil according to claim 3, wherein the frame comprises a connection wall, the second insertion piece is secured to the connection wall, the protrusion portion and the frame are of an integral structure, and the protrusion portion is arranged to protrude in a direction away from an axis of the frame relative to the connection wall.

5. The electromagnetic coil according to claim 1, wherein the protrusion portion comprises a winding segment and a blocking end, the winding segment is disposed on the frame and is configured for a part of the output end to be wound around the winding segment, the blocking end is disposed on an end of the winding segment facing away from the frame, two ends of the blocking end protrude from the winding segment in a width direction of the winding segment, and a protruding length of each of the two ends is greater than a diameter of the wire.

6. The electromagnetic coil according to claim 1, wherein the frame comprises a winding portion, a first stop portion, and a second stop portion; the winding portion is configured for the wire to be wound on the winding portion; the first stop portion and the second stop portion are disposed on two axial ends of the winding portion; a radial size of each of the first stop portion and the second stop portion is greater than a radial size of the winding portion; the first insertion piece is disposed on a circumferential side of the first stop portion; and the second insertion piece is disposed on a circumferential side of the second stop portion.

7. The electromagnetic coil according to claim 6, wherein the protrusion portion is disposed on at least one of the first stop portion and the second stop portion.

8. The electromagnetic coil according to claim 6, wherein a wire inlet guide groove is disposed on a circumferential side wall of the first stop portion.

9. The electromagnetic coil according to claim 6, wherein a wire outlet guide groove is disposed on a circumferential side wall of the second stop portion, and the protrusion portion is located beside a wire outlet of the wire outlet guide groove.

10. The electromagnetic coil according to claim 8, wherein a wire outlet guide groove is disposed on a circumferential side wall of the second stop portion, and the protrusion portion is located beside a wire outlet of the wire outlet guide groove.

11. The electromagnetic coil according to claim 8, wherein a groove bottom wall of the wire inlet guide groove is a smooth transitional arc surface.

12. The electromagnetic coil according to claim 9, wherein a groove bottom wall of the wire outlet guide groove is a smooth transitional arc surface.

13. The electromagnetic coil according to claim 8, wherein a stopper is disposed on an end of the wire inlet guide groove facing the first insertion piece, and the stopper protrudes outward from a groove wall of the wire inlet guide groove in a depth direction of the wire inlet guide groove.

14. The electromagnetic coil according to claim 8, wherein a side of the first stop portion facing the second stop portion is defined as a first reference wall;
a wire inlet extension groove communicating with the wire inlet guide groove is disposed on the first reference wall, and the wire inlet extension groove extends from a circumferential surface of the first stop portion to a circumferential surface of the winding portion.

15. The electromagnetic coil according to claim 9, wherein a side of the second stop portion facing the first stop portion is defined as a second reference wall;
a wire outlet extension groove communicating with the wire outlet guide groove is disposed on the second reference wall, and the wire outlet extension groove extends from a circumferential surface of the second stop portion to the circumferential surface of the winding portion.

16. The electromagnetic coil according to claim 1, wherein a pressing portion is disposed on the first insertion piece, and the pressing portion is rotatable relative to the first insertion piece so that the pressing portion presses a part of the input end on the first insertion piece;

17. The electromagnetic coil according to claim 1, wherein a pressing portion is disposed on the second insertion piece, and the pressing portion is rotatable relative to the second insertion piece so that the pressing portion presses a part of the output end on the second insertion piece.

18. An assembly method of an electromagnetic coil, used for assembling an electromagnetic coil, wherein the electromagnetic coil comprises:
a frame, wherein a protrusion portion is disposed on the frame;
a first insertion piece and a second insertion piece disposed on two axial ends of the frame respectively; and
a wire wound on the frame and having an input end and an output end, wherein the input end is connected to the first insertion piece, and the output end is configured to be wound on the protrusion portion and then connected to the second insertion piece;
wherein the assembly method comprises:
in S30, partially winding and securing an output end on a protrusion portion after winding a wire on a frame is completed;
in S40, assembling a second insertion piece on the frame; and
in S50, connecting the output end to the second insertion piece.

19. The assembly method of an electromagnetic coil according to claim 18, wherein a wire inlet guide groove is disposed on a circumferential side wall on an axial end of the frame; and before S30, the assembly method further comprises:
in S10, assembling a first insertion piece on the frame; passing the input end through the wire inlet guide groove and connecting the input end to the first insertion piece; and
in S20, winding the wire on the frame.

20. The assembly method of an electromagnetic coil according to claim 18, wherein a wire outlet guide groove is disposed on an other axial end of the frame, and the protrusion portion is located beside a wire outlet of the wire outlet guide groove;
S30 comprises: after completing winding the wire on the frame, passing the output end through the wire outlet guide groove, guiding the output end onto the protrusion portion, and partially winding and securing the output end on the protrusion portion.
